(19) United States
(12) Patent Application Publication
(10) Pub. No.: US 2016/0364785 A1
(43) Pub. Date: Dec. 15, 2016

(54) AUTOMATED IN STORE SHOPPING SYSTEM

(71) Applicant: International Business Machines Corporation, Armonk, NY (US)

(72) Inventor: Vinod Kumar L. Wankhede, Bentonville, AR (US)

(21) Appl. No.: 14/734,077

(22) Filed: Jun. 9, 2015

(51) Int. Cl. G06Q 30/06; G06Q 20/12

(52) U.S. Cl. CPC G06Q 30/0633; G06Q 20/12; G06Q 30/0639

(57) ABSTRACT

Embodiments of the present invention provide a method, computer program product, and system for automated shopping. The method includes generating a route to items within a location and directing a robotic cart to collect the items according to the generated route. A list of items to be collected is received from a user located at a remote location. A purchase items list is generated of the collected items. As each item on the list of items is collected, it is added to the purchase items list. The method may also include remote payment by a user for the items listed on the purchase items list.

### BACKGROUND OF THE INVENTION

The present invention relates generally to the field of shopping, and more particularly to automated retrieval of items using GPS navigation and robotics to locate and capture items.

Robotics is the branch of mechanical engineering, electrical engineering, and computer science that deals with the design, construction, operation, and application of robots, as well as computer systems for their control, sensory feedback, and information processing. These technologies deal with automated machines that can take the place of humans in dangerous environments or manufacturing processes, or resemble humans in appearance, behavior, and/or cognition.

### SUMMARY

A method for automated shopping comprising, the method comprising the steps of: receiving, by one or more computer processors, a list of items at a location; generating, by one or more computer processors, a route to the list of items at the location; directing, by one or more computer processors, a cart to follow the generated route and to retrieve the list of items; generating, by one or more computer processors, a second list comprising retrieved items; requesting, by one or more computer processors, payment for the retrieved items; and receiving, by one or more computer processors, an indication of payment.

A computer program product comprising: a computer readable storage medium and program instructions stored on the computer readable storage medium, the program instructions comprising: program instructions to receive a list of items at a location; program instructions to generate a route to said list of items at the location; program instructions to direct a cart to follow said generated route and to retrieve said list of items; program instructions to generate a second list comprising retrieved items; program instructions to request payment for the retrieved items; and program instructions to receive an indication of payment.

A robotic cart system comprising: a chassis, the chassis having a robotic arm, wherein the robotic arm is coupled to the chassis; a gripper assembly, wherein the gripper assembly is coupled to the robotic arm; a control unit; at least one moving device coupled to the chassis, the at least one moving device being operatively connected to the control unit to move the chassis around a location according to instructions received from the control unit; at least one direction device coupled to the chassis, the at least one direction device being operatively connected to the control unit to direct the chassis to move around a location according to instructions received from the control unit; a navigation system, wherein said navigation system is configured to locate a list of items in a location and generate a route to collect the list of items; at least one obstacle sensor; a barcode scanner; and a power source.

### BRIEF DESCRIPTION OF THE DRAWINGS

FIG. 1 is a functional block diagram illustrating an environment, in accordance with an embodiment of the present invention;

FIG. 2 is a diagram depicting external components of a robotic cart, in accordance with an embodiment of the present invention;

FIG. 3 is a flowchart depicting operational steps for fulfilling an automated shopping request, in accordance with an embodiment of the present invention;

FIG. 4 is a diagram depicting an example plan view of a store in which items are collected from racks, in accordance with an embodiment of the present invention; and

FIG. 5 is a block diagram of internal and external components of a computer system, in accordance with an embodiment of the present invention.

### DETAILED DESCRIPTION

Customers often are not in the mood to go grocery shopping. Grocery stores can be very busy with customers, and the process of grocery shopping can take a long time. During busy hours, other customers and workers cause congestion throughout the aisles of the store, discouraging shopping in the deepest sections therein. Sometimes customers get frustrated in the process of locating items within the store. There is also a human tendency to forget items during shopping, which aren't remembered until after leaving the store. Embodiments of the present invention provide systems and methods for increasing the efficiency of shopping using robotic carts and an automated shopping program, which manages the robotic carts and communications with external hosts.

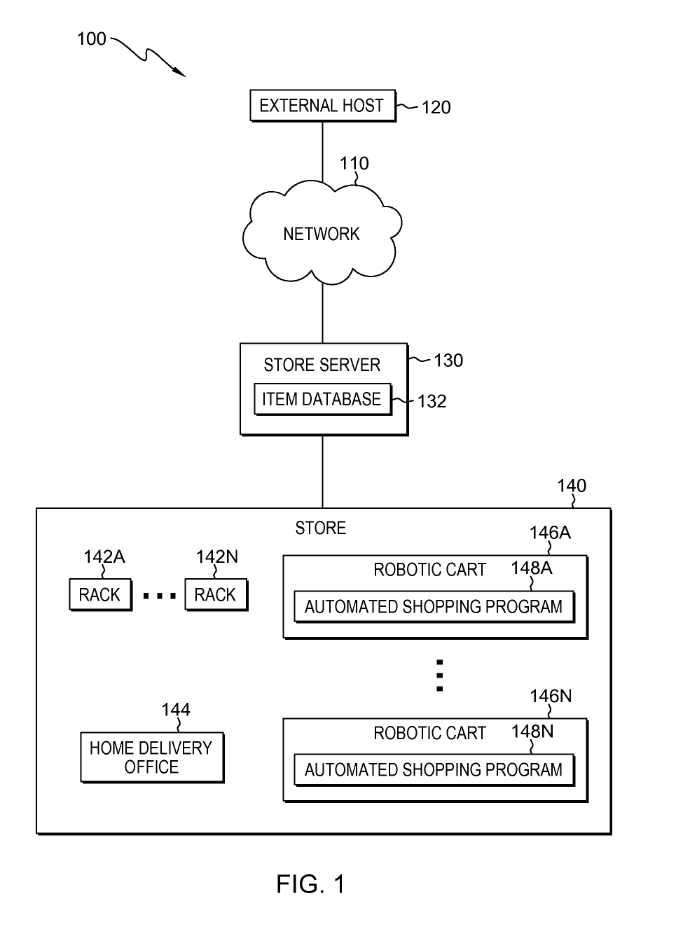

The present invention will now be described in detail with reference to the figures. FIG. 1 is a functional block diagram illustrating an automated shopping data processing environment (“environment”), generally designated 100, in accordance with one embodiment of the present invention. FIG. 1 provides only an illustration of one implementation, and does not imply any limitations with regard to the environments in which different embodiments may be implemented. Many modifications to the depicted environment may be made by those skilled in the art without departing from the scope of the invention as recited by the claims. In an exemplary embodiment, environment 100 includes store 140, store server 130, and external host 120 connected to store server 130 over network 110.

Network 110 can be, for example, a local area network (LAN), a wide area network (WAN) such as the Internet, or a combination of the two, and can include wired, wireless, or fiber optic connections. In general, network 110 can be any combination of connections and protocols that will support communication between external host 120 and store server 130.

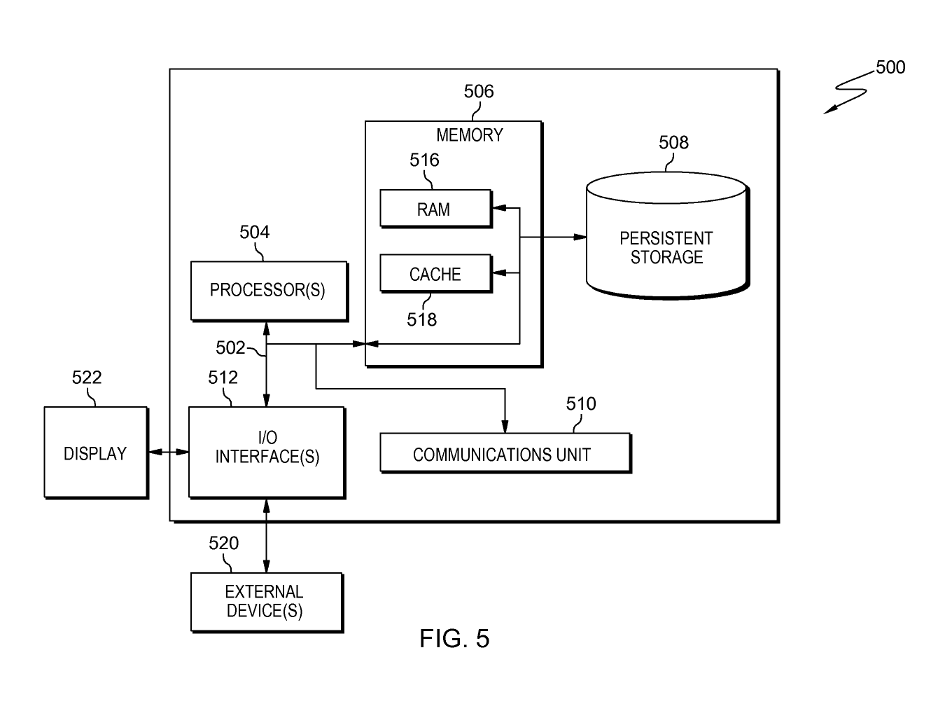

External host 120 may be a computing device, such as a laptop computer, a tablet computer, a netbook computer, a personal computer (PC), a desktop computer, a personal digital assistant (PDA), a smart phone, a thin client, or any programmable electronic device capable of communicating with store server 130 via network 110. In other embodiments, external host 120 may be a management server, a web server, or any other electronic device or computing system capable of receiving and sending data. External host 120 may include internal and external hardware components, as depicted and described in further detail with respect to FIG. 5.

Store 140 includes racks 142A through 142N (142A-N), home delivery office 144, and robotic carts 146A through 146N (146A-N). Any number of racks 142A-N and any number of robotic carts 146A-N may be added to, or removed from, store 140 as required to support the management of store items. For example, when five (5) additional racks 142A-N are added to store 140, two (2) additional robotic carts 146A-N may be added to store 140 to support the increase in-store items. Store 140 is an automated shopping center and is capable of communicating data to and from external host 120, via store server 130. Home delivery office 144 is a location within store 140 where items are prepared for in-store pickup or packaged for home delivery (i.e., delivery to the home of a user).

In this exemplary embodiment, racks 142A-N contain shelves to hold items. Racks 142A-N are capable of being positioned according to the floor size of store 140 and the amount of items stored within store 140. In this exemplary embodiment, each of racks 142A-N can be moved close together to reduce overall occupied floor space, and are capable of being positioned apart in order to allow more access to requested items. In this exemplary embodiment, racks 142A-N are each capable of supporting multiple different items. For example, cereal, coffee, tea, and oatmeal among other items, may be stored on the same item rack. In other embodiments, each of racks 142A-N contain one type of item. For example, frozen vegetables, ice cream, and frozen pizzas among other frozen items, may be stored on the same rack. In this exemplary embodiment, racks 142A-N are capable of being adapted to use with new item storage technologies (i.e., new frozen food refrigerators, new produce storage bins, etc.).

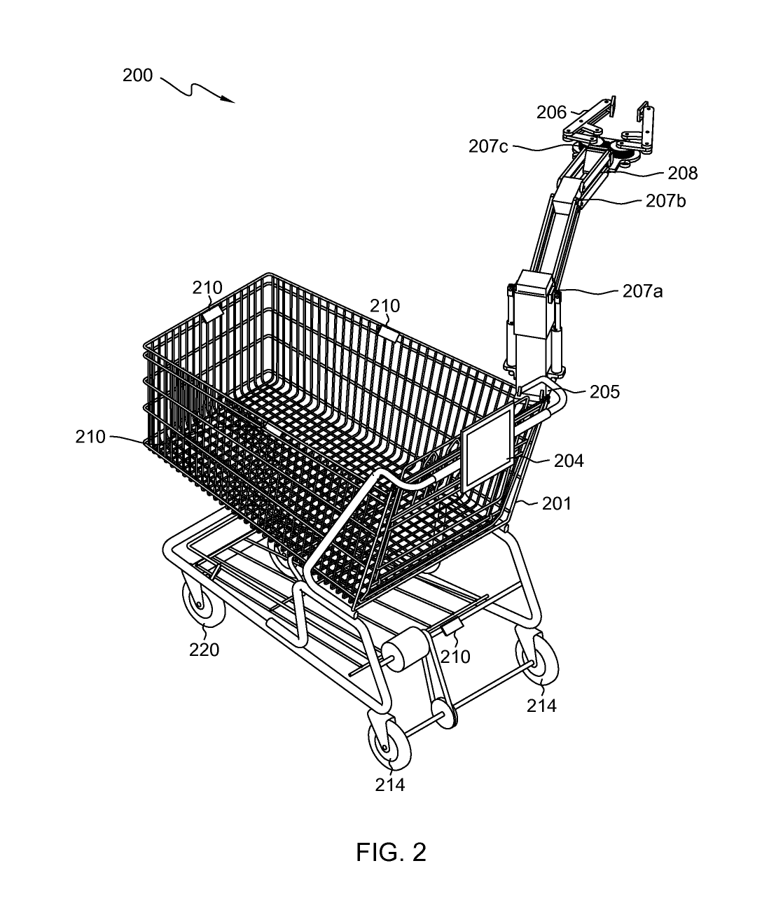

In this exemplary embodiment, robotic carts 146A-N are capable of movement in the x- and y-coordinate directions and capable of transporting items from racks 142A-N to home delivery office 144 within store 140. Robotic arm 208 (FIG. 2) removes items from the shelves of racks 142A-N using gripper assembly 206 (FIG. 2), scans the items, and places the items into the cart.

In this exemplary embodiment, robotic carts 146A-N each include a respective automated shopping program 148A through 148N (148A-N). Automated shopping programs 148A-N receive a data request from an external host 120 via store server 130, and send item data to the requesting external host 120 via store server 130. Automated shopping programs 148A-N control the movement of each of robotic carts 146A-N. In this exemplary embodiment, automated shopping programs 148A-N are capable of locating items within racks 142A-N, instructing robotic carts 146A-N to scan the item, and place the items into the cart. Automated shopping programs 148A-N can generally include any software capable of directing robotic carts 146A-N and communicating with external host 120 through store server 130. Automated shopping programs 148A-N are a list of instructions to be used by robotic carts 146A-N for the purposes of locating and collecting items available within store 140. In this exemplary embodiment, automated shopping programs 148A-N processes requests from external host 120. Automated shopping programs 148A-N are capable of optimizing, and communicating with, the various components within store 140. In this exemplary embodiment, automated shopping programs 148A-N are capable of accessing item database 132 to determine a location of the requested item on racks 142A-N. In this exemplary embodiment, automated shopping programs 148A-N store the position and status of each of robotic carts 146A-N, such as battery status of each cart, defects of each cart, and completion percentage of each cart in use. Automated shopping programs 148A-N are capable of determining one or more of robotic carts 146A-N to retrieve and read the requested item data. Automated shopping programs 148A-N are capable of communicating with store server 130 to receive item retrieval requests. Automated shopping programs 148A-N are capable of receiving retrieved item data and sending the item data to external host 120.

Store server 130 includes item database 132. Store server 130 may be a management server, a web server, or any other electronic device or computing system capable of receiving and sending data. In other embodiments of the present invention, store server 130 can represent a computing system utilizing clustered computers and components to act as a single pool of seamless resources when accessed through a network. In this exemplary embodiment, store server 130 is capable of receiving requests for data from external host 120, via network 110. Store server 130 may include internal and external hardware components, as depicted and described in further detail with respect to FIG. 5.

Item database 132 is a central storage for a set of store item data. In this exemplary embodiment, item database 132 contains the location and access information for each item located in store 140. For example, item database 132 may contain item codes (e.g., item barcodes), store shelf numbers, item positions within each of racks 142A-N, the category of each item (e.g., produce or paper products), and the time of access of each item, among other information. In this exemplary embodiment, item database 132 receives updated item location information from automated shopping programs 148A-N, and may be accessed by automated shopping programs 148A-N.

FIG. 2 depicts a block diagram of external components of robotic cart 200, in accordance with an embodiment of the present invention. Robotic carts 146A-N may each be implemented with robotic cart 200.

In this exemplary embodiment, robotic cart 200 is an autonomous robot vehicle. Robotic cart 200 includes two moving devices 214, which are located on two opposing sides at the rear of chassis 201, and two direction devices 220, which are located on two opposing sides (only one side shown in FIG. 2) at the front of chassis 201. Moving devices 214 and direction devices 220 direct and move robotic cart 200 in store 140. In this exemplary embodiment, moving devices 214 and direction devices 220 are wheel devices connected to a power source (e.g., a battery) and contain a navigation sensor, which provides position data and distance traveled feedback to automated shopping programs 148A-N of robotic cart 200. Robotic cart 200 comprises a plurality of obstacle sensors 210 located on each side to prevent collisions with any obstacle in store 140. Obstacle sensors 210 identify proximity to racks 142A-N, robotic carts 146A-N, and any obstruction and relay information to navigation system 204. Navigation system 204 controls the movement of robotic cart 200 within store 140. In other embodiments, any number of moving devices 214 and any number of direction devices 220 may be placed in any location on chassis 201, which allows movement of robotic cart 200 in store 140. In this exemplary embodiment, moving devices 214 and direction devices 220 are capable of rotating clockwise and counterclockwise around a horizontal axis, and direction devices 220 are capable of rotating 360 degrees around a vertical axis. In other embodiments, one or more of moving devices 214 and one or more direction devices 220 may rotate in one or more directions around a horizontal axis, and may rotate up to 360 degrees around a vertical axis.

Robotic cart 200 includes robotic arm 208, mounted to chassis 201 by mount 205 and connected to gripper assembly 206 by pivot assembly 207c. In this exemplary embodiment, robotic arm 208 is mounted to the top of chassis 201 by mount 205 and is able to move in two directions across mount 205, as well as rotate 360 degrees around the vertical axis at the mount point. It should be appreciated, however, that robotic arm 208 can be mounted at any other suitable location on chassis 201 (e.g., to the side of chassis 201). In this exemplary embodiment, robotic arm 208 has three pivoting joints: pivot mount 207a, pivoting joint 207b, and pivot assembly 207c, which support movement of robotic arm 208 in multiple directions. For example, pivot mount 207a is mounted to chassis 201 and can rotate 360 degrees around the vertical axis, as well as 180 degrees around the horizontal axis. In this exemplary embodiment, robotic arm 208 includes one pivoting joint 207b, which can rotate around a horizontal axis. Pivot assembly 207c is a mounting platform connecting gripper assembly 206 to robotic arm 208, and can rotate 180 degrees around the vertical axis. In other embodiments, robotic arm 208 may include one or more of pivoting joint 207b which supports movement of robotic arm 208, each pivoting joint 207b rotating up to 360 degrees in one or more axes. Gripper assembly 206 is an end effector, or a device coupled to the end of robotic arm 208 designed to interact with the environment. In this exemplary embodiment, gripper assembly 206 is an electromechanical gripper device capable of identifying, retrieving, and moving an item. In other embodiments, gripper assembly 206 may include one or more of: a camera; a barcode scanner; a radio frequency identification (RFID) reader for identifying the requested items; one or more grippers; and a navigation sensor to locate positions within store 140, mounted to one of the grippers. The exact nature of gripper assembly 206 is based on different physical effects used to guarantee a stable grasping between a gripper and the object to be grasped, and depends on the application of robotic cart 200. In this exemplary embodiment, gripper assembly 206 contains a barcode scanner (not shown in FIG. 2), and three grippers, which are designed to pick up and place items and to work with varying item shapes, sizes, and storage systems. In other embodiments, gripper assembly 206 may be any rapid exchange gripper mechanism technology which supports the retrieval and movement of items, or other tasks in store 140 (e.g., opening frozen food storage doors). For example, gripper assembly 206 can be impactive (jaws or claws which physically grasp by direct impact upon the object), ingressive (pins, needles, or hackles which physically penetrate the surface of the object), abstrictive (vacuum, magnetic, or electroadhesion forces are applied to the surface of the object), and contigutive (requiring direct contact for adhesion to occur, such as glue, surface tension, or freezing). In this exemplary embodiment, robotic arm 208 and/or gripper assembly 206 also contain a navigation sensor (not shown in FIG. 2), which provides position data feedback to automated shopping programs 148A-N of robotic cart 200.

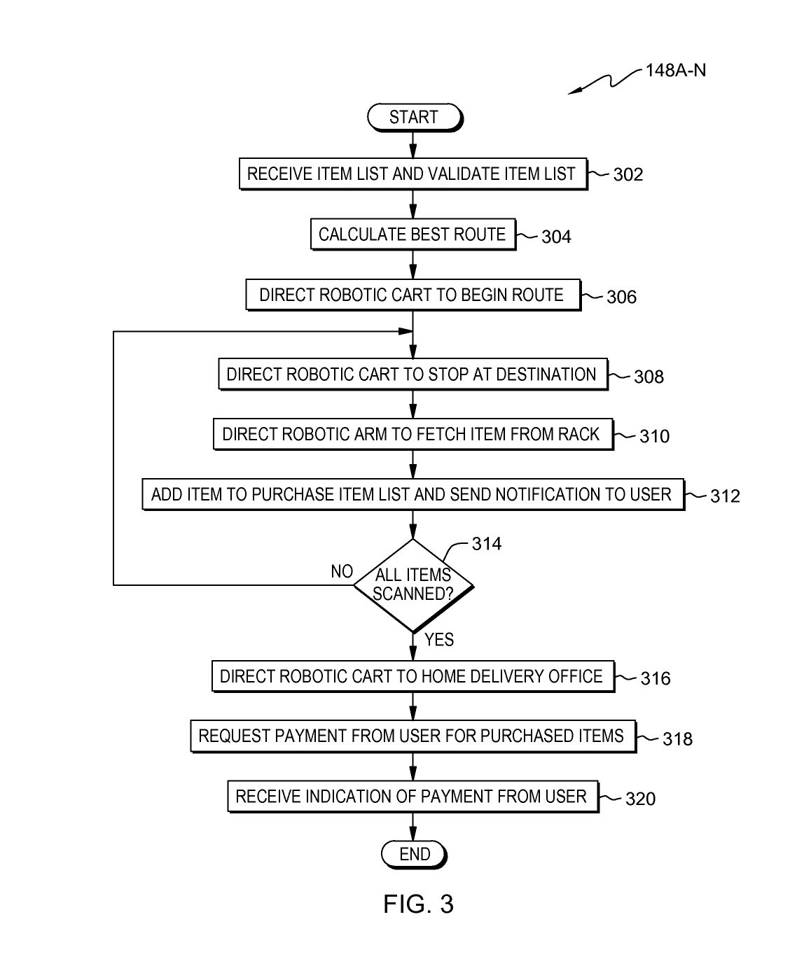

FIG. 3 is a flowchart depicting operational steps of automated shopping programs 148A-N for fulfilling an automated shopping request, in accordance with an embodiment of the present invention. For illustrative purposes, the following discussion is made with respect to robotic cart 146A and automated shopping program 148A; it being understood that the operational steps of FIG. 3 may be performed by any of robotic carts 146A-N using any of automated shopping programs 148A-N.

In step 302, automated shopping program 148A receives a list from a user. In this exemplary embodiment, automated shopping program 148A receives a request from external host 120, via network 110, for items within store 140. The list may include grocery items, clothing, sports equipment, etc. Automated shopping program 148A validates the list with items available in store 140. In this exemplary embodiment, automated shopping program 148A searches item database 132 to identify the location within store 140 of the requested items. If an item does not exist within item database 132, then automated shopping program removes that item from the list and notifies external host 120 that that item does not exist within store 140.

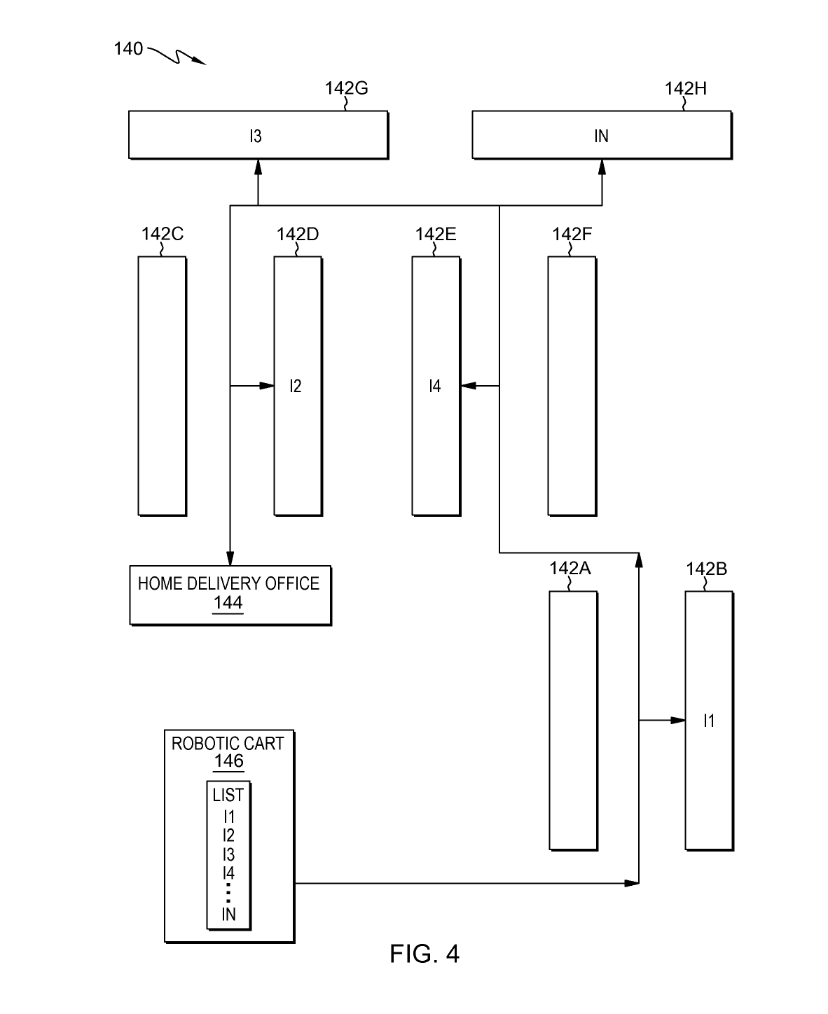

In step 304, automated shopping program 148A calculates the best route to collect each item on the list within store 140. In this exemplary embodiment, automated shopping program 148A chooses the shortest route that collects each item on the list. For the purposes of this invention, it is assumed that, because all of robotic carts 146A-N use automated shopping program 148A, the shortest route is also the quickest route. Step 304 is described in further detail with respect to FIG. 4.

In step 306, automated shopping program 148A directs robotic cart 146A to begin the calculated route. In this exemplary embodiment, robotic cart 146A proceeds to the first scheduled stop to collect a first item. It should be appreciated that the first scheduled stop is determined by the route calculated in step 304, and is not necessarily at the first item listed on the list.

In step 308, automated shopping program 148A directs robotic cart 146A to stop at the destination. In this exemplary embodiment, automated shopping program 148A directs robotic cart 146A to stop at the destination of an item from the list. The destination of the item is determined by the route calculated in step 304.

In step 310, automated shopping program 148A directs robotic arm 208 to fetch the item from racks 142A-N. In this exemplary embodiment, robotic arm 208 collects the item from racks 142A-N, scans the item with a barcode scanner located on gripper assembly 206, and places the item in the cart. Robotic arm 208 utilizes pivot mount 207a, pivoting joint 207b, and pivot assembly 207c to properly position gripper assembly 206 so as to capture the item from racks 142A-N.

In step 312, automated shopping program 148A adds the scanned item to the purchase item list and sends a notification to external host 120, via network 110. In this exemplary embodiment, automated shopping program 148A automatically updates the list and sends a notification to the user that robotic cart 146A has collected and scanned the item from racks 142A-N.

In step 314, automated shopping program 148A determines whether all of the items listed on the list of items have been collected, scanned, and added to the purchase item list.

If, in step 314, automated shopping program 148A determines that all items of the list have not been collected by robotic cart 146A, then automated shopping program 148A directs robotic cart 146A to stop at the next destination. In this exemplary embodiment, this process (i.e., steps 308-314) will repeat until each item on the list is collected by robotic cart 146A.

If, in step 314, automated shopping program 148A determines that all items on the list have been collected by robotic cart 146A, then in step 316 automated shopping program 148A directs robotic cart 146A to proceed to home delivery office 144. In this exemplary embodiment, the route is complete once every item on the list is collected and scanned, and robotic cart 146A then proceeds to home delivery office 144 for checkout and packaging.

In step 318, automated shopping program 148A requests payment from the user for purchased items. In this exemplary embodiment, the cost of payment is calculated from the items on the purchase items list and the appropriate sales tax. Payment may be made through external host 120, or in person at store 140. In this exemplary embodiment, the user can enter coupons through external host 120, and the cost will be adjusted accordingly. The user also has the option to select home delivery (i.e., delivery to the home of a user) or in-store pickup.

In step 320, automated shopping program 148A receives indication of payment from the user. In this exemplary embodiment, automated shopping program 148A receives indication of payment from external host 120, via network 110. The purchased items can then be delivered to the user's home or the user can pick the items up at store 140.

Accordingly, by performing the operational steps of FIG. 3, the items of a shopping list can be collected and paid for without the customer being present in the store.

FIG. 4 depicts an example plan view of store 140, in which items are collected from racks 142A-H, in accordance with an embodiment of the present invention. In this exemplary embodiment, store 140 includes racks 142A, 142B, 142C, 142D, 142E, 142F, 142G, and 142H. Racks 142A-H may be positioned to create alleys for robotic carts 146A-N within store 140. Robotic carts 146A-N are autonomous android vehicles capable of moving around the floor of store 140 and moving between racks 142A-H. Automated shopping program 148A receives an item list (step 302) that includes five example items labeled I1, I2, I3, I4, and IN. Automated shopping program 148A identifies the location of each item within store 140 (step 302). Item I1 is located at rack 142B, item I2 is located at rack 142D, item I3 is located at rack 142G, item I4 is located at rack 142E, and item IN is located at 142H. In this exemplary embodiment, automated shopping program 148A calculates the best route (step 304) to collect item I1, item I2, item I3, item I4, and item IN from store 140 as follows: robotic cart 146A travels to rack 142B to collect item I1, to rack 142E to collect item I4, to rack 142H to collect item IN, to rack 142G to collect item I3, and to rack 142D to collect item I2. Then, automated shopping program 148A directs robotic cart 146A to proceed to home delivery office 144 (step 318) where the collected items will be prepared for either home delivery or in-store pickup.

FIG. 5 is a block diagram of internal and external components of computing device 500, which is representative of the computing devices of FIG. 1, in accordance with an embodiment of the present invention. It should be appreciated that FIG. 5 provides only an illustration of one implementation and does not imply any limitations with regard to the environments in which different embodiments may be implemented. In general, the components illustrated in FIG. 5 are representative of any electronic device capable of executing machine-readable program instructions. Examples of computer systems, environments, and/or configurations that may be represented by the components illustrated in FIG. 5 include, but are not limited to, personal computer systems, server computer systems, thin clients, thick clients, laptop computer systems, tablet computer systems, cellular telephones (i.e., smart phones), multiprocessor systems, microprocessor-based systems, network PCs, minicomputer systems, mainframe computer systems, and distributed cloud computing environments that include any of the above systems or devices.

Computing device 500 includes communications fabric 502, which provides for communications between one or more processing units 504, memory 506, persistent storage 508, communications unit 510, and one or more input/output (I/O) interfaces 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer readable storage media. In this embodiment, memory 506 includes random access memory (RAM) 516 and cache memory 518. In general, memory 506 can include any suitable volatile or non-volatile computer readable storage media. Software is stored in persistent storage 508 for execution and/or access by one or more of the respective processors 504 via one or more memories of memory 506.

Persistent storage 508 may include, for example, a plurality of magnetic hard disk drives. Alternatively, or in addition to magnetic hard disk drives, persistent storage 508 can include one or more solid state hard drives, semiconductor storage devices, read-only memories (ROM), erasable programmable read-only memories (EPROM), flash memories, or any other computerreadable storage media that is capable of storing program instructions or digital information.

The media used by persistent storage 508 can also be removable. For example, a removable hard drive can be used for persistent storage 508. Other examples include optical and magnetic disks, thumb drives, and smart cards that are inserted into a drive for transfer onto another computerreadable storage medium that is also part of persistent storage 508.

Communications unit 510 provides for communications with other computer systems or devices via a network. In this exemplary embodiment, communications unit 510 includes network adapters or interfaces such as a TCP/IP adapter cards, wireless Wi-Fi interface cards, or 3G or 4G wireless interface cards or other wired or wireless communications links. The network can comprise, for example, copper wires, optical fibers, wireless transmission, routers, firewalls, switches, gateway computers and/or edge servers. Software and data used to practice embodiments of the present invention can be downloaded to computing device 500 through communications unit 510 (i.e., via the Internet, a local area network, or other wide area network). From communications unit 510, the software and data can be loaded onto persistent storage 508.

One or more I/O interfaces 512 allow for input and output of data with other devices that may be connected to computing device 500. For example, I/O interface 512 can provide a connection to one or more external devices 520 such as a keyboard, computer mouse, touch screen, virtual keyboard, touch pad, pointing device, or other human interface devices. External devices 520 can also include portable computerreadable storage media such as, for example, thumb drives, portable optical or magnetic disks, and memory cards. I/O interface 512 also connects to display 522.

Display 522 provides a mechanism to display data to a user and can be, for example, a computer monitor. Display 522 can also be an incorporated display and may function as a touch screen, such as a built-in display of a tablet computer.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for automated shopping, the method comprising the steps of:
receiving, by one or more computer processors, a list of items at a location;
generating, by one or more computer processors, a route to said list of items at the location;
directing, by one or more computer processors, a cart to follow said generated route and to retrieve said list of items;
generating, by one or more computer processors, a second list comprising retrieved items;
requesting, by one or more computer processors, payment for the retrieved items; and
receiving, by one or more computer processors, an indication of payment.

2. The method of claim 1, further comprising:
verifying, by one or more computer processors, that said list of items is present at the location; and
notifying, by one or more computer processors, a user of items that do not exist at said location.

3. The method of claim 1, further comprising:
responsive to determining that an item is not present at said location, removing said item from said list of items.

4. The method of claim 1, wherein generating a route to said list of items comprises:
locating, by one or more computer processors, a position of said items within the location; and
calculating, by one or more computer processors, a path to collect said list of items, said path having the shortest distance to collect said list of items.

5. The method of claim 4, further comprising:
notifying, by one or more computer processors, a remote user of an estimated shopping time for said path to collect said list of items.

6. The method of claim 1, further comprising:
collecting, by a gripper assembly, an item on said list of items;
scanning, by a barcode scanner, said item; and
adding, by one or more computer processors, said item to the second list.

7. The method of claim 6, wherein collecting an item on said list of items comprises:
identifying an item from said list of items;
picking up an item located on a rack; and
placing said item in said robotic cart.

8. A computer program product comprising:
a computer readable storage medium and program instructions stored on the computer readable storage medium, the program instructions comprising:
program instructions to receive a list of items at a location;
program instructions to generate a route to said list of items at the location;
program instructions to direct a cart to follow said generated route and to retrieve said list of items;
program instructions to generate a second list comprising retrieved items;
program instructions to request payment for the retrieved items; and
program instructions to receive an indication of payment.

9. The computer program product of claim 8, further comprising:
program instructions to verify that said list of items is present at the location; and
program instructions to notify a user of items that do not exist at said location.

10. The computer program product of claim 8, further comprising:
program instructions to, responsive to determining that an item is not present at said location, remove said item from said list of items.

11. The computer program product of claim 8, wherein the program instructions to generate a route to said list of items comprises:
program instructions to locate a position of said items within the location; and
program instructions to calculate a path to collect said list of items, said path having the shortest distance to collect said list of items.

12. The computer program product of claim 11, further comprising:
program instructions to notify a remote user of an estimated shopping time for said path to collect said list of items.

13. The computer program product of claim 8, further comprising:
program instructions to collect, by a gripper assembly, an item on said list of items;
program instructions to scan, by a barcode scanner, said item; and
program instructions to add said item to the second list.

14. The computer program product of claim 13, wherein the program instructions to collect an item on said list of items comprises:
program instructions to identify an item from said list of items;
program instructions to pick up an item located on a rack; and
program instructions to place said item in said robotic cart.

15. A robotic cart system comprising:
a chassis, the chassis having a robotic arm, wherein the robotic arm is coupled to the chassis;
a gripper assembly, wherein the gripper assembly is coupled to said robotic arm;
a control unit;
at least one moving device coupled to said chassis, the at least one moving device being operatively connected to the control unit to move the chassis around a location according to instructions received from the control unit;
at least one direction device coupled to said chassis, the at least one direction device being operatively connected to the control unit to direct the chassis to move around a location according to instructions received from the control unit;
a navigation system, wherein said navigation system is configured to locate a list of items in a location and generate a route to collect the list of items;
at least one obstacle sensor;
a barcode scanner; and
a power source.

16. The robotic cart system of claim 15, wherein said chassis is configured to follow the generated route to collect the list of items.

17. The robotic cart system of claim 15, wherein said chassis is configured to receive payment information from a user, and wherein said user is at another location.

18. The robotic cart system of claim 15, wherein said chassis is configured to receive a list of items from a user, wherein said user is at another location.

19. The robotic cart system of claim 15, wherein the at least one obstacle sensor is configured to: identify an obstacle; and direct said chassis to move around the obstacle.

20. The robotic cart system of claim 15, wherein said gripper assembly comprises an impactive end effector having a plurality of fingers.
